(19) United States
(12) Patent Application Publication
(10) Pub. No.: US 2014/0096047 A1
(43) Pub. Date: Apr. 3, 2014

(54) ELECTRONIC APPARATUS, METHOD OF EXECUTING APPLICATION, AND COMPUTER READABLE RECORDING MEDIUM

(71) Applicant: SAMSUNG Electronics Co., Ltd., Suwon-si (KR)

(72) Inventors: Kwang-soo HA, Seoul (KR); Su-yong KIM, Yongin-si (KR); Hee-jeong KIM, Seoul (KR); Jun-seok PARK, Seoul (KR); Hyung-do LEE, Seoul (KR)

(73) Assignee: SAMSUNG Electronics Co., Ltd., Suwon-si (KR)

(21) Appl. No.: 13/956,513

(22) Filed: Aug. 1, 2013

(30) Foreign Application Priority Data
Sep. 28, 2012 (KR) 10-2012-0109574

(51) Int. Cl. G06F 3/0481

(52) U.S. Cl. CPC G06F 3/04817
USPC 715/768

(57) ABSTRACT

An electronic apparatus includes a storage unit which stores a plurality of applications, a management unit which manages a list of applications that have been already selected from among the plurality of applications stored in the storage unit, a user interface which applies transparency to a shortcut region which includes an icon corresponding to each application included in the list, and displays the transparent shortcut region, and a controller which, if one of the displayed icons is selected, drives an application corresponding to the selected icon.

### CROSS-REFERENCE TO RELATED APPLICATIONS

This application claims priority under 35 U.S.C. §119 from Korean Patent Application No. 10-2012-0109574, filed on Sep. 28, 2012, in the Korean Intellectual Property Office, the disclosure of which is incorporated herein by reference in its entirety.

### BACKGROUND OF THE INVENTION

1. Field of the Invention

Methods and apparatuses consistent with exemplary embodiments relate to an electronic apparatus, a method of executing an application, and a computer readable recording medium, and more particularly, to an electronic apparatus which can easily execute a desktop application, a method of executing an application, and a computer readable recording medium.

2. Description of the Related Art

Computers process a series of calculations implemented by a logical language and are equipped with an operating system to operate a hardware system efficiently.

A personal computer (PC) software program is diversifying with the development of system performance and storage spaces. Many pieces of software program are installed and used in a system by user's selection or via various routes.

In general, the PC software program easily guides execution of software program which has been frequently used using a shortcut icon method. However, such a shortcut icon method sporadically leaves icons on wallpaper if the icons are not well managed. Also, as data dealt with by users through networks geometrically increases in recent years, icons on wallpaper are required to be managed.

### SUMMARY OF THE INVENTION

One or more exemplary embodiments provide an electronic apparatus, which can easily execute a desktop application, a method of executing an application, and a computer readable recording medium.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an electronic apparatus including a storage unit to store a plurality of applications, a management unit to manage a list of applications that have been already selected from among the plurality of applications stored in the storage unit, a user interface to apply transparency to a shortcut region which includes an icon corresponding to each application included in the list, and to display the transparent shortcut region, and a controller which, if one of the displayed icons is selected, drives an application corresponding to the selected icon.

If a mouse pointer is placed on the icon, the user interface may change the icon on which the mouse pointer is placed to a bubble icon and may display the bubble icon.

The user interface may not apply transparency to an icon which is displayed on the shortcut region, and may apply transparency to a part of the shortcut region on which an icon is not displayed.

The user interface may further includes at least one of a third icon which receives a command to display the plurality of applications stored in the storage unit, and a fourth icon which receives a command to change setting of the shortcut region in the shortcut region, and may display the at least one of the third icon and the fourth icon.

The management unit may group the already selected applications according to a predetermined category, and the user interface may display a second icon which corresponds to the category of the grouped applications along with the icon.

If a mouse pointer is placed on the second icon or if the second icon is selected, the user interface may display an extended shortcut region which includes an icon corresponding to each of the applications grouped according to the category on a lower portion or an upper portion of the second icon.

The user interface may display the icon in the extended shortcut region in a different size from that of the icon in the shortcut region.

If an icon in the extended shortcut region is moved to the shortcut region, the management unit may exclude an application corresponding to the moved icon from the group corresponding to the second icon.

If a command to move one of the icons is input, the user interface may display the icon which is instructed to be moved on a mouse pointer or a touch location of a user.

The management unit may update the list based on a location on which the icon which is instructed to be moved is placed.

If the icon which is instructed to be moved is placed over another icon, the management unit may group the icon which is instructed to be moved and another icon into one category.

If the icon which is instructed to be moved is placed over a second icon corresponding to application grouped according to a category, the management unit may add an application corresponding to the icon which is instructed to be moved to the category.

The foregoing and/or other features and utilities of the present general inventive concept may also be achieved by providing a method of executing an application of an electronic apparatus, the method including managing a list of applications that have been already selected from among a plurality of application pre-stored in the electronic apparatus, applying transparency to a shortcut region which includes an icon corresponding to each application included in the list, and displaying the transparent shortcut region, selecting one of the displayed icons, and driving an application corresponding to the selected icon.

The displaying may include, if a mouse pointer is placed on the icon, changing the icon on which the mouse pointer is placed to a bubble icon, and displaying the bubble icon.

The displaying may not apply transparency to an icon which is displayed on the shortcut region, and may apply transparency to a part of the shortcut region on which an icon is not displayed.

The displaying may include further including at least one of a third icon which receives a command to display the plurality of applications stored in the storage unit, and a fourth icon which receives a command to change setting of the shortcut region in the shortcut region, and displaying the at least one of the third icon and the fourth icon.

The managing may include grouping the already selected applications according to a predetermined category, and the displaying may include displaying a second icon which corresponds to the category of the grouped applications along with the icon.

The displaying may include, if a mouse pointer is placed on the second icon or if the second icon is selected, displaying an extended shortcut region which includes an icon corresponding to each of the applications grouped according to the category on a lower portion or an upper portion of the second icon.

The displaying may include displaying the icon in the extended shortcut region in a different size from that of the icon in the shortcut region.

The managing may include, if an icon in the extended shortcut region is moved to the shortcut region, excluding an application corresponding to the moved icon from the group corresponding to the second icon.

The displaying may include, if a command to move one of the icons is input, displaying the icon which is instructed to be moved on a mouse pointer or a touch location of a user.

The managing may include updating the list based on a location on which the icon which is instructed to be moved is placed.

The managing may include, if the icon which is instructed to be moved is placed over another icon, grouping the icon which is instructed to be moved and another icon into one category.

The managing may include, if the icon which is instructed to be moved is placed over a second icon corresponding to applications grouped according to a category, adding an application corresponding to the icon which is instructed to be moved to the category.

The foregoing and/or other features and utilities of the present general inventive concept may also be achieved by providing a computer readable recording medium which includes a program to execute a method of executing an application of an electronic apparatus, the method including: managing a list of applications that have been already selected from among a plurality of application pre-stored in the electronic apparatus, applying transparency to a shortcut region which includes an icon corresponding to each application included in the list, and displaying the transparent shortcut region, selecting one of the displayed icons; and driving an application corresponding to the selected icon.

The foregoing and/or other features and utilities of the present general inventive concept may also be achieved by providing an electronic apparatus including a storage unit to store a plurality of applications, and a user interface to display on a display screen a user interface window including a shortcut region, the shortcut region including one or more first icons to correspond to a first number of applications and a second icon to correspond a second number of applications as a group according to a category, and to change a characteristic of the shortcut region according to a movement of a cursor within the shortcut region.

The electronic apparatus may further include a controller to execute one of the applications according to a selection of one of the first icons and the second icon.

The user interface may control the user interface window to include an extended shortcut region to include one or more sub-second icons to correspond to the second number of applications included in the second icon as a group.

The first number of applications and the second number of application may include one or more common applications.

The user interface window may include a third icon to correspond to the applications as a list.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram illustrating an electronic apparatus according to an exemplary embodiment of the present general inventive concept;

FIG. 2 is a block diagram illustrating a controller of the electronic apparatus of FIG. 1;

FIGS. 3 to 15 are views illustrating various examples of a user interface window, which is displayable on a user interface of the electronic apparatus of FIG. 1;

FIG. 16 is a flowchart illustrating a method of executing an application according to an exemplary embodiment of the present general inventive concept;

FIG. 17 is a flowchart illustrating a method of executing an application according to an exemplary embodiment of the present general inventive concept;

FIG. 18 is a flowchart illustrating a movement of an icon in a shortcut region;

FIG. 19 is a flowchart illustrating a process of managing a plurality of icons as one icon; and

FIG. 20 is a flowchart illustrating an operation of displaying when a second icon is selected.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

The matters defined in the description, such as detailed construction and elements, are provided to assist in a comprehensive understanding of exemplary embodiments. Thus, it is apparent that exemplary embodiments can be carried out without those specifically defined matters. Also, functions or elements known in the related art are not described in detail since they would obscure the exemplary embodiments with unnecessary detail.

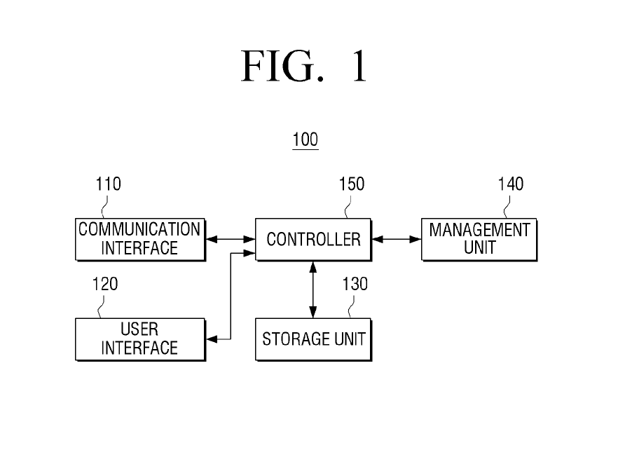

FIG. 1 is a block diagram illustrating an electronic apparatus 100 according to an exemplary embodiment of the present general inventive concept.

Referring to FIG. 1, the electronic apparatus 100 according to an exemplary embodiment includes a communication interface 110, a user interface 120, a storage unit 130, a management unit 140, and a controller 150. The electronic apparatus 100 may be a personal computer (PC), a notebook computer, a tablet PC, a portable multimedia player (PMP), or a mobile phone, in which various applications (or software or programs) are driven.

The communication interface 110 is configured to connect the electronic apparatus 100 to an external apparatus (not shown), and may access the external apparatus through a local area network (LAN) or the internet, or may access the external apparatus in a wireless communication method (for example, GSM, UMTS, LTE, or WiBRO).

The communication interface 110 may receive an application from an external apparatus (not illustrated). The application may be installed in the electronic apparatus 100 by the controller 150, and may be stored in a pre-set folder of the storage unit 130.

The user interface 120 may include a plurality of function keys through which a user sets or selects various functions supported by the electronic apparatus 100, and may display diverse information provided by the electronic apparatus 100. The user interface 120 may be realized by an apparatus which performs input and output simultaneously such as a touch screen, and may be realized by an apparatus combining a mouse and a monitor. The user interface 120 may include a touch screen and also may include a mouse and a monitor.

The user interface 120 may display a shortcut region (or a quick starter region). Specifically, the user interface 120 may apply transparency to the shortcut region which includes an icon (or an item) corresponding to each application included in a list (hereinafter, referred to as a first icon), and may display the transparent shortcut region. The transparency recited herein is applied to display wallpaper, while displaying the shortcut region. The transparency may be applied to an entire portion of the shortcut region or may be applied to only a region (a portion of the shortcut region) on which an icon is not located. By applying the transparency to the shortcut region and displaying the transparent shortcut region, the shortcut region and the wallpaper may be superimposed such that a user can recognize both the shortcut region and the wallpaper.

The user interface 120 may arrange and display the icons based on at least one of installing time of the applications included in the list, frequency of execution, and whether a user has manipulated the applications. If the icons are grouped (i.e., the icons are combined or classified into one or more groups) according to one or more predetermined categories, the user interface 120 may display a second icon (or a category icon) indicating the grouped icons along with the first icon.

The shortcut region may be displayed only if a mouse pointer is placed on a predetermined location. For example, the shortcut region is hidden or located in a certain area of a user interface window when a different job is performed on a screen and appears when the mouse pointer is placed on a certain area, such as, a lowermost side (or an uppermost side, a right side end, or a left side end) of the user interface window, or when the wallpaper is displayed.

If the mouse pointer is placed on one of the plurality of icons, the user interface 120 may change the icon on which the mouse pointer is placed to a bubble icon and may display the bubble icon. The bubble icon recited herein refers to an icon an image of which is enclosed by a transparent sphere like a bubble. The bubble icon may be applied to the second icon, a third icon, and a fourth icon besides the first icon.

If the mouse pointer is placed on the second icon or the user selects the second icon (for example, if the user touches the second icon using a touch screen), the user interface 120 may display an extended shortcut region on an upper or lower region of the selected second icon. The extended shortcut region displays a first icon corresponding to each application included in the category corresponding to the second icon. At this time, the user interface 120 may display the first icon in the extended shortcut region in a different size from that of the first icon in the shortcut region. In the present exemplary embodiment, if the mouse pointer is placed on the second icon, the extended shortcut region is displayed. However, the present general inventive concept is not limited thereto. It is possible that if the mouse pointer is placed on the second icon, the first icon of each of the plurality of applications corresponding to the second icon may be displayed on the location of the second icon in sequence, and then, if the second icon is selected, the extended shortcut region may be displayed.

The user interface 120 may display at least one of the third icon which receives a command to display a plurality of applications stored in the storage unit 130, and the fourth icon which receives a command to change setting of the shortcut region, along with the first icon.

If the third icon is selected from among the plurality of icons, the user interface 120 may display the plurality of applications pre-stored in the storage unit 130 (or applications pre-installed in the electronic apparatus) in a form of a list. At this time, the user interface 120 may arrange and display the applications based on at least one of installing time of the plurality of pre-installed desktop applications, whether the application is included in the list, and frequency of execution. The user may select an application to execute on the user interface window, and may install a shortcut icon regarding the corresponding application on the wallpaper or may add the shortcut icon to the shortcut region (that is, the list) described above.

If the fourth icon is selected from among the plurality of icons, the user interface 120 may display a user interface window to change the setting of the shortcut region. Using such a user interface window, the user may adjust the transparency of the shortcut region or may group the applications in the list.

If a command to move one of the plurality of icons is input or received, the user interface 120 may display the icon which is instructed to be moved on a location of the mouse pointer or a touch location of the user. Specifically, if one of the icons included in the shortcut region or the extended shortcut region is selected by clicking and dragging, or is selected by clicking or touching after a moving command has been input or received, the user interface 120 may move the selected icon according to a movement of a mouse pointer location or a movement of a touch location of the user, and may display the icon. The selected icon may move until the user places the mouse pointer on the shortcut region or the extended shortcut region.

If the icon which is instructed to be moved is placed in a predetermined region, the user interface 120 may display a predetermined image effect. Specifically, if the icon which is instructed to be moved approaches a region in which the corresponding icon can be placed (for example, between two icons), the user interface 120 may indicate the region using light or may highlight the region. If the icon is moved through the above-described process, the list may be updated. Specifically, icon location information in the list may be updated. The user interface 120 displays the plurality of icons according to the updated list. That is, the user interface 120 may display the icons by reflecting the changed location state.

The storage unit 130 stores a program to drive the electronic apparatus 100. Specifically, the storage unit 130 may store a program which is a set of commands necessary to drive the electronic apparatus 100. The program may include an operating system and various applications.

The storage unit 130 stores the list. Specifically, the storage unit 130 may store the list (that is, the application added to the shortcut region) which is managed by the management unit 140, which will be described later. One list is managed in the present exemplary embodiment. However, if the electronic apparatus 100 has a plurality of operation modes (for example, a first operation mode in which a desktop application is driven and a second operation mode in which a metro application different from the desktop application is driven), a list of applications executable in the first operation mode may be separately stored. In this case, a list of applications executable in the first operation mode may be stored as a first list, and applications which have been already selected from among the applications of the first list may be stored as a second list.

The storage unit 130 stores various icons. Specifically, the storage unit 130 may store the first icon corresponding to each of the applications, the second icon corresponding to the category, the third icon, and the fourth icon.

The storage unit 130 may be realized by an internal storage medium or an external storage medium of the electronic apparatus 100, for example, a removable disk including a USB memory and a flash memory, a storage medium which is connected to the electronic apparatus, or a web server connected through a network.

The management unit 140 manages the list regarding the applications which have been already selected from among the applications. Specifically, if applications to be displayed on the shortcut region are selected by the user, the management unit 140 may manage the selected applications as a list.

If the list of the applications installed in the electronic apparatus 100 is displayed on the user interface 120 and the user moves one of the applications in the list to the shortcut region by dragging it, the management unit 140 manages the dragged applications as a list.

If a command to delete (or remove) one of the first icons (or second icons) displayed on the shortcut region is received, the management unit 140 may delete an application corresponding to the first icon (or the second icon) which is instructed to be deleted from the list.

The management unit 140 may arrange the applications included in the list. Specifically, the management unit 140 may arrange the applications in the list based on installing time of each of the applications, whether the application has been used recently, frequency of execution, and user's location modification. For example, if the icon which is instructed to be moved is placed in a location different from its existing location, the management unit 140 may update the order of the applications in the list according to the locations in which the icons are currently placed.

The management unit 140 may group the plurality of applications in the corresponding list according to one or more predetermined categories. For example, the management unit 140 may group a plurality of document creating applications into one document creating group, and may group music reproducing applications and moving picture reproducing applications into a multimedia group. The operation of grouping may be performed by a user's selection or may be performed automatically if the number of applications in the list is greater than or equal to a predetermined number.

Although the plurality of applications are grouped according to the predetermined categories in the present exemplary embodiment, a portion of applications which does not belong to the category may be grouped into one group according to a user's selection. For example, if an icon that is instructed to be moved is placed over another icon, the management unit 140 may group the icon which is instructed to be moved and another icon into one category. Also, if the icon which is instructed to be moved is placed over the second icon, the management unit 140 may add an application corresponding to the icon instructed to be moved to the category corresponding to the second icon.

The controller 150 controls the elements of the electronic apparatus 100. Specifically, if the mouse pointer is placed on a predetermined region by a user's manipulation or if wallpaper of the operating system is displayed, the controller 150 may control the user interface 120 to display the shortcut region.

If the mouse pointer is placed on one of the icons of the shortcut region, the controller 150 may control the user interface 120 to change the icon on which the mouse pointer is placed to a bubble icon, and display the bubble icon. If the mouse pointer is placed on the second icon, the controller 150 may control the user interface 120 to display the extended shortcut region on an upper or lower region of the second icon.

If the first icon is selected, the controller 150 may drive an application corresponding to the selected first icon. If the second icon is selected, the controller 150 may control the user interface 120 to display icons of a plurality of applications corresponding to the second icon on the extended shortcut region.

If the third icon is selected, the controller 150 may control the user interface 120 to display the list of the applications installed in the electronic apparatus 100. If the fourth icon is selected, the controller 150 may control the user interface 120 to display the user interface window to adjust the setting of the shortcut region.

If a command to move an icon is received, the controller 150 may control the management unit 140 to update the list according to a location on which the icon which is instructed to be moved is placed.

Since the electronic apparatus 100 according to the present exemplary embodiment described above provides the user with the shortcut region having the icon regarding the application that the user has frequently used, the user can easily execute the application. Also, since the electronic apparatus 100 according to the present exemplary embodiment applies transparency to the shortcut region, the shortcut region may be distinguished from a background and also a difference between the shortcut region and the wallpaper on which a customized user interface is actively performed may not be recognized or may be minimized using visual illusion.

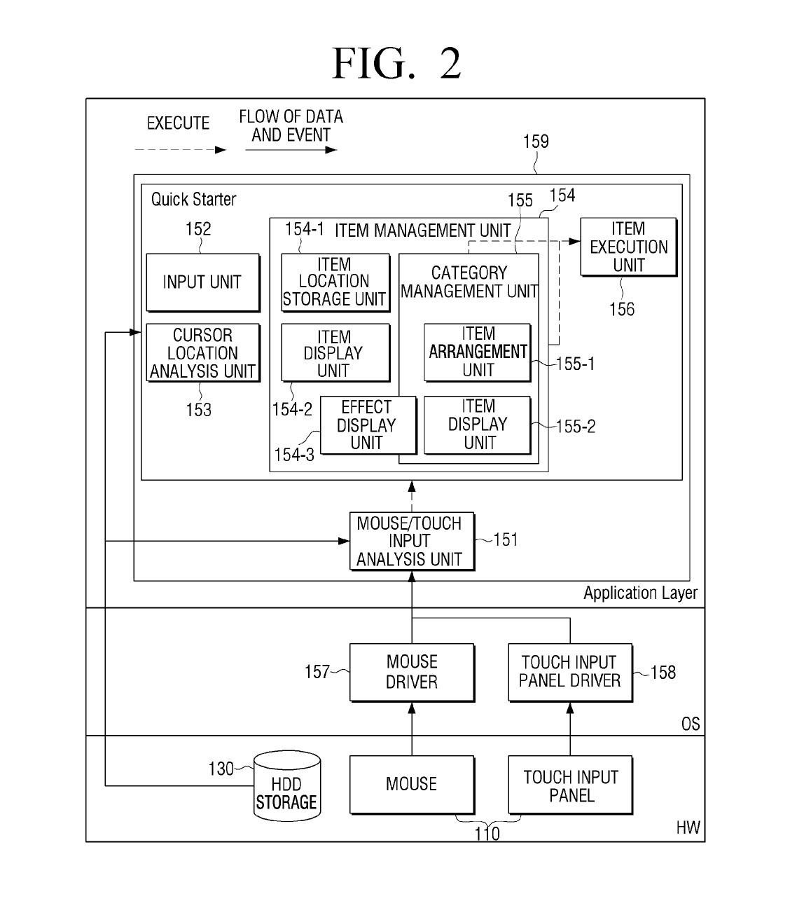

Although the management unit 140 and the controller 150 are separate elements in FIG. 1, the function of the management unit 140 and the function of the controller 150 may be incorporated into a single element in practice. This exemplary embodiment will be explained below with reference to FIG. 2.

FIG. 2 is a view illustrating the controller 150 of the electronic apparatus 100 of FIG. 1.

Referring to FIG. 2, the controller 150 may include an application layer and an OS layer.

The OS layer manages computer resources such as the storage unit 130 and the user interface 120, while serving as an interface between hardware and an application. The OS may include a mouse driver 157 and a touch input panel driver 158.

The application layer is a layer in which an application is operated on the OS. The application layer may include a quick starter application 159 and a mouse/touch input analysis unit 151 as illustrated in FIG. 2.

The mouse/touch input analysis unit 151 receives location information of the mouse pointer and mouse click information from the mouse driver 157, receives location information of user touch from the touch input panel driver 158, and provides the received information to the quick starter application 159.

The quick starter application 159 is an application that displays the shortcut region on a predetermined location when the mouse pointer is placed on a predetermined location or the wallpaper is displayed. Accordingly, the user can be provided with the same effect as described simply by installing the quick starter application in the related-art OS.

The quick starter application 159 may include an input unit 152, a cursor location analysis unit 153, an item management unit 154, and an item execution unit 156.

The input unit 152 receives a command to drive the quick starter application.

Specifically, a series of operations of displaying the shortcut region is performed if the user clicks or touches a start menu of the quick starter application.

The cursor location analysis unit 153 senses a current location of a mouse cursor in the shortcut region.

The item management unit 154 includes an item location storage unit 154-1, an item display unit 154-2, an effect display unit 154-3, and a category management unit 155.

The item location storage unit 154-1 stores locations of the icons regarding the applications included in the list in the shortcut region. If the user changes a location of an icon in the shortcut region, the location of each icon may be updated.

The item display unit 154-2 stores icon information of each of the applications included in the list. The item display unit 154-2 may display the first icon, the second, and the fourth icon included in the list on the shortcut region.

The effect display unit 154-3 may apply transparency to the shortcut region and display the transparent shortcut region.

If the mouse cursor is placed on an icon, the effect display unit 154-3 may replace the icon on which the mouse cursor is placed with a bubble icon. If the mouse cursor is placed on the second icon, the effect display unit 154-3 may replace the second icon with a bubble icon or may display first icons of the plurality of applications corresponding to the second icon in sequence. If an icon which is instructed to be moved is placed between other icons, the effect display unit 154-3 indicates that the icon which is instructed to be moved can be placed between the two icons by light or highlights the icon which is instructed to be moved between two icons.

The item display unit 153-2 stores icon information of each of the desktop applications included in the list. If the first icon on the shortcut region is selected, the item display unit 153-2 may display the icon corresponding to each of the applications in the list using the list and the icon information.

The category management unit 155 includes an item arrangement unit 155-1 and an item display unit 155-2.

The item arrangement unit 155-1 may group the desktop applications included in the list according to a predetermined category. The predetermined category may be a developer of an application (for example, developer A and developer B), or a type of an application (game, multimedia, or word processor).

The item display unit 155-2 stores information on an icon regarding the applications which are grouped according to a category (specifically, the second icon). The item display unit 155-2 may display the second icon on the shortcut region. If the second icon is selected, the item display unit 155-2 may display the first icon of each of the plurality of desktop applications corresponding to the second icon on the extended shortcut region.

If one of the first icons displayed on the shortcut region is selected, the item execution unit 156 executes an application corresponding to the selected first icon.

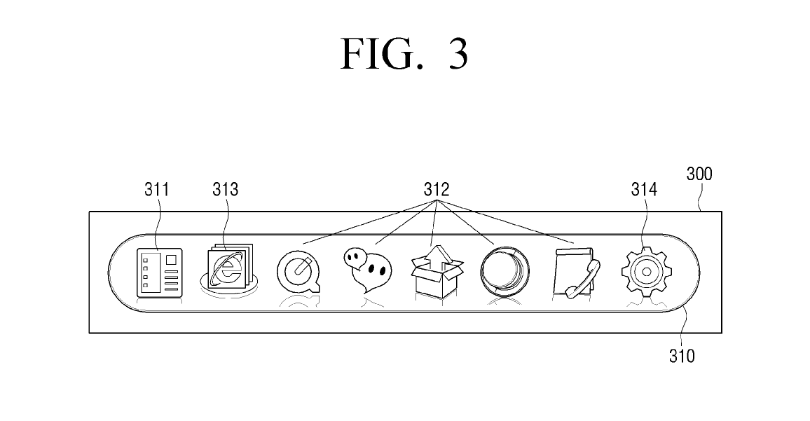

FIGS. 3 to 15 are views illustrating various examples of a user interface window which is displayable on the user interface 120 of the electronic apparatus of FIG. 1.

Referring to FIG. 3, a user interface window 300 includes a shortcut region 310. The shortcut region 310 may be displayed if the user inputs a wallpaper view command or the user places a mouse pointer on a predetermined portion of a screen, for example, a lower end (or an upper end, a right end, or a left end) of the user interface window 300.

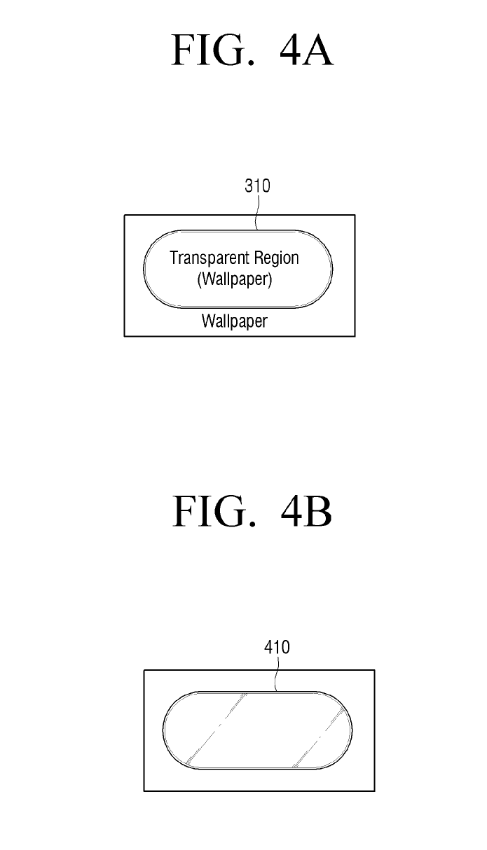

The shortcut region 310 includes first icons 312, a second icon 313, a third icon 311, and a fourth icon 314. Transparency may be applied to the shortcut region and the transparent shortcut region will be explained below with reference to FIG. 4.

The first icon 312 is an icon that corresponds to an application included in a list. If such a first icon 312 is selected, an application corresponding to the selected first icon 312 is executed. Although FIG. 3 illustrates a plurality of first icons to be displayed in the shortcut region 310, one first icon may be displayed in the shortcut region 310 if the list includes one application.

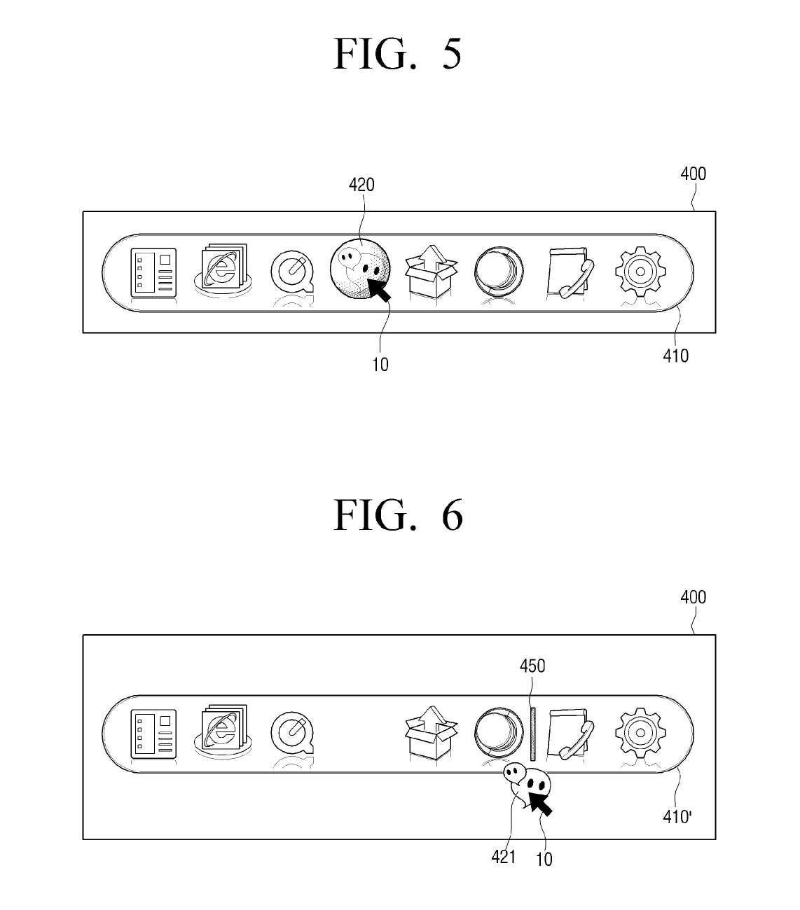

If the user places the mouse pointer on the first icon 312 prior to selecting the first icon 312, a user interface window 400 illustrated in FIG. 5 may be displayed.

The second icon 313 is an icon that corresponds to a category of grouped applications. The second icon 313 may be generated according to a user command or may be generated automatically if the number of first icons is greater than or equal to a predetermined number.

If the mouse pointer is placed on the second icon 313, first icons of the plurality of applications corresponding to the selected second icon 313 may be displayed in sequence. If the mouse pointer is placed on the second icon 313, an extended shortcut region may be displayed on a lower end of the second icon 313 as shown in FIG. 10.

If the mouse pointer is placed on the second icon 313, the first icons of the plurality of applications corresponding to the second icon 313 may be displayed in sequence, and, if the second icon 313 is selected, the extended shortcut region may be displayed.

The third icon 311 is an icon that receives a command to display an application installed in the electronic apparatus 100. If the third icon 311 is selected, a list of the applications that are installed in the electronic apparatus 100 may be displayed on a separate user interface window.

The fourth icon 314 is an icon that receives a command to change setting of the shortcut region. If the fourth icon 314 is selected, a user interface window to change the setting of the shortcut region may be displayed. The user may group the applications in the list or may adjust the transparency of the shortcut region using such a user interface window.

Referring to FIG. 4, transparency may be applied to the shortcut region 310 so that the wallpaper can be seen through the shortcut region. Since the transparent shortcut region 310 is displayed, the shortcut region 310 can harmonize with the wallpaper and also may be distinguished from the wallpaper using visual illusion.

Referring to FIG. 5, a shortcut region 410 displays the first icon in a different shape in comparison with the shortcut region 310 of FIG. 3.

Specifically, if a mouse pointer 10 is placed on the first icon 312, the first icon 312 is changed to a bubble icon 420, which is enclosed by a transparent sphere like a bubble, and the bubble icon 420 is displayed. Accordingly, the user can easily recognize an icon on which the current cursor is placed from among the plurality of icons.

If the first icon 420 is selected in this state, an application corresponding to the selected first icon 420 is executed.

If a user selection is performed by clicking and dragging rather than clicking or by clicking after a moving command has been input, the corresponding icon is moved as illustrated in FIG. 6. This will be explained below with reference to FIG. 6.

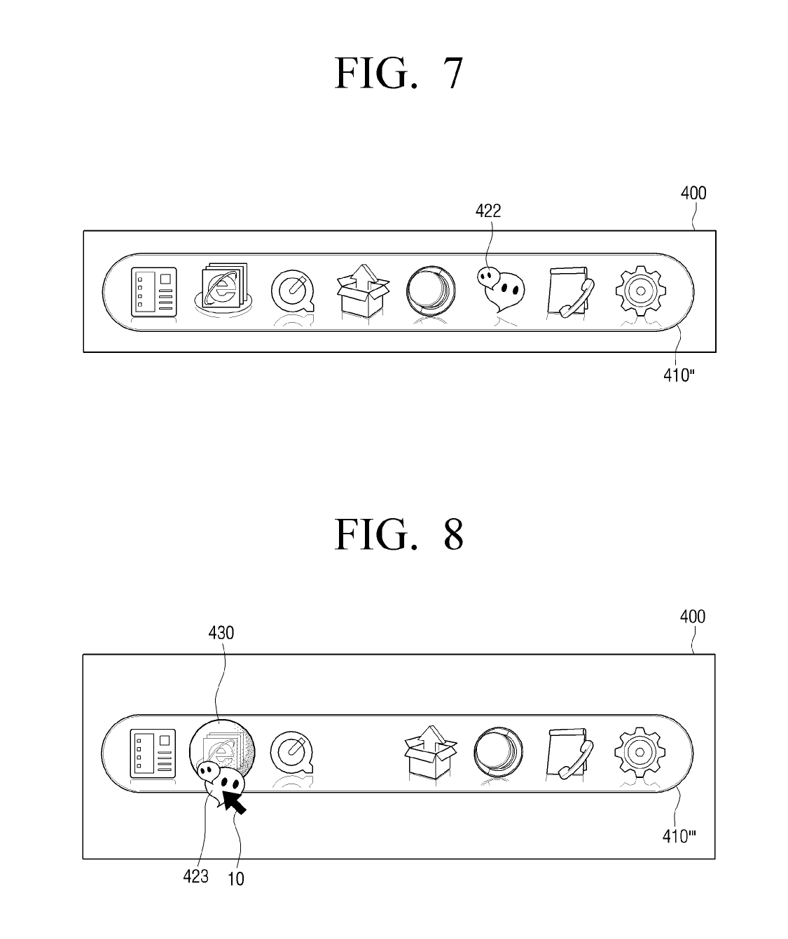

Referring to FIGS. 6 and 7, a shortcut region 410′ of FIG. 6 changes a location of the first icon selected by the user in comparison with the shortcut region 410 of FIG. 5.

Specifically, if one of the plurality of icons is selected by clicking and dragging or is clicked or touched after a moving command has been input, the selected icon 420 is moved according to a movement of the mouse pointer 10 or a movement of a touch location of the user.

If the icon approaches a specific region while being moved, light or a flickering effect 450 may be displayed, indicating that the icon can be placed on a corresponding location.

If the user places the icon on the corresponding location 450, the icon 420 selected by the user is moved to the location of the shortcut region and is displayed there as illustrated in FIG. 7.

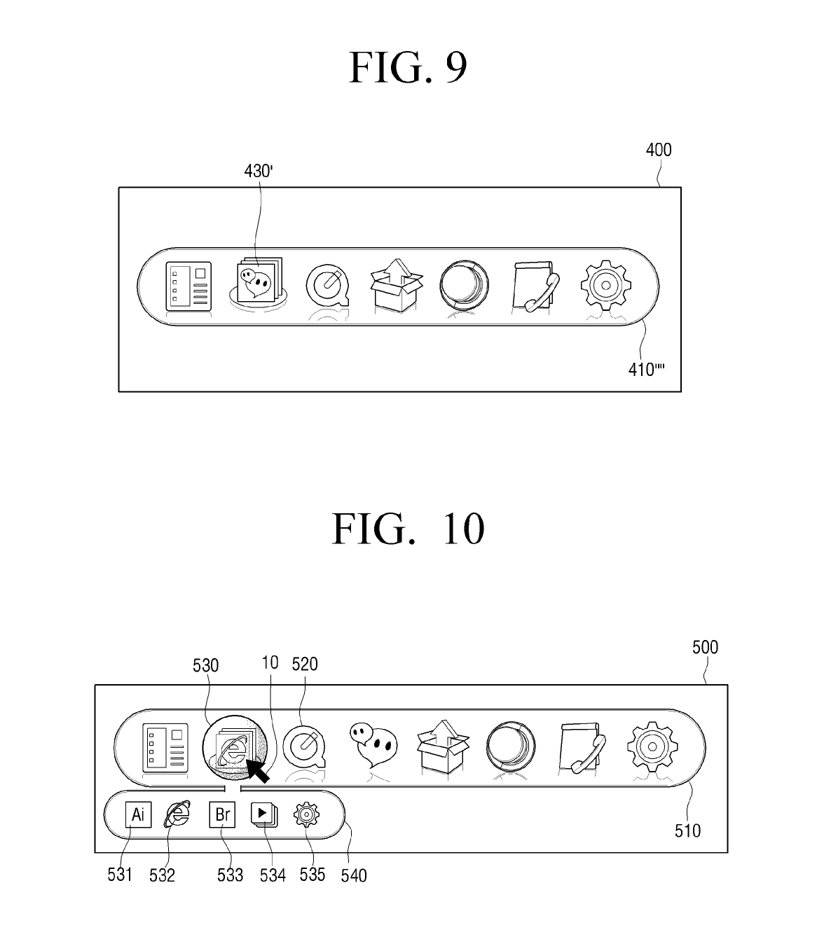

In the above exemplary embodiment, the selected icon is placed in an empty space in the shortcut region. However, the selected icon may be placed over another icon. This will be explained below with reference to FIGS. 8 and 9.

Referring to FIGS. 8 and 9, the icon 422 of FIG. 7 selected by the user is placed as an icon 423 over the second icon 430 according to the movement of the mouse pointer 10. Accordingly, the second icon 430 is changed to a bubble icon and is displayed in the form of the bubble icon.

After that, if the icon 423 selected by the user is placed over the second icon 430, the application corresponding to the selected icon 423 is included in the group of the second icon 430′. Accordingly, a region on which the first icon 422 has been placed disappears on the shortcut region 410″″ as illustrated in FIG. 9.

The displaying operation performed if the first icon is selected has been explained in the above exemplary embodiment, and hereinafter, an operation performed if the user selects the second icon will be explained with reference to FIGS. 10 to 14.

Referring to FIG. 10, a shortcut region 510 of FIG. 10 disposed in a user interface window 500 changes a shape of a second icon 530 and extends a shortcut region from a lower end of the second icon 530 in comparison with the shortcut region 310 of FIG. 3. Hereinafter, the shortcut region additionally displayed under the second icon 530 will be referred to as an extended shortcut region 540.

Specifically, if the mouse pointer 10 is placed on the second icon 530, the second icon 530 is changed to a bubble icon 430 which is enclosed by a transparent sphere like a bubble, and the bubble icon 430 is displayed. Accordingly, the user can easily recognize an icon on which the current cursor is placed from among the plurality of icons. In the above example, the second icon 530 is just changed to the bubble icon 430. However, the present general inventive concept is not limited thereto. It is possible that if the mouse pointer is placed on the second icon 530, first icons of the plurality of applications corresponding to the selected second icon 530 may be displayed in sequence. Also, the first icons corresponding to the second icon may be changed to bubble icons and may be displayed on the location of the second icon.

In this state, if the second icon 530 is selected or the mouse pointer is placed on the second icon 530 for more than a predetermined time, the extended shortcut region corresponding to the second icon 530 may be displayed. At this time, the extended shortcut region 540 includes the first icons 531, 532, 533, 534, and/or 535 of the plurality of applications corresponding to the second icon 530.

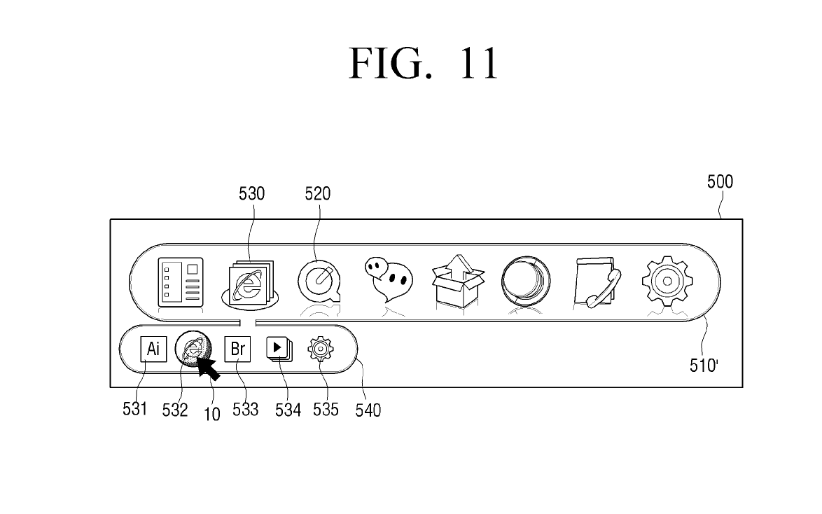

If the user places the mouse pointer 10 on a first icon 532 in the extended shortcut region 540 when the extended shortcut region 540 is displayed, the first icon 532 is changed to a bubble icon 532′ which is enclosed by a transparent sphere like a bubble and the bubble icon 532′ as illustrated in FIG. 11 is displayed. Accordingly, the user can easily recognize the icon on which the current cursor is placed from among the plurality of icons.

In this state, if the first icon 532′ is selected, an application corresponding to the selected first icon 532′ is executed.

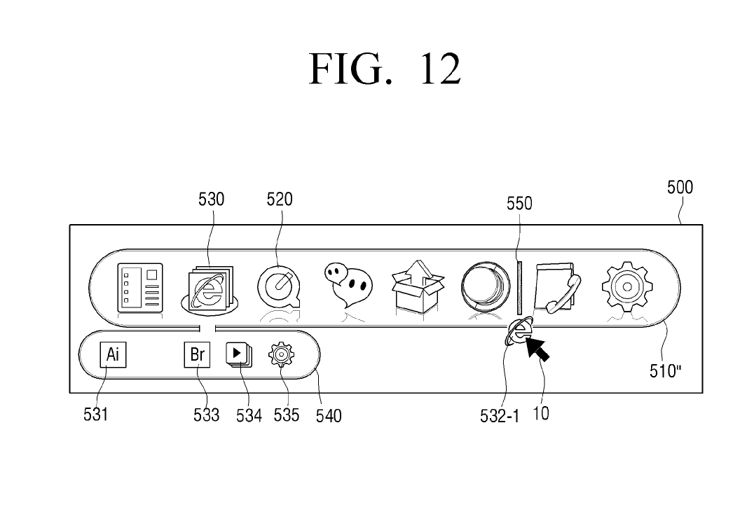

If a user selection is clicking and dragging rather than clicking or is clicking after a moving command has been input, an icon 531-1 corresponding to the icon 532 may be moved according to a cursor or touch movement as illustrated in FIG. 12. This will be explained in detail with reference to FIGS. 12 to 14.

Referring to FIG. 12, a shortcut region 510″ of FIG. 12 changes a location of the first icon 532 selected by the user in comparison with the shortcut region 510 of FIG. 11.

Specifically, if one of the icons is selected by clicking and dragging or is clicked or touched after a moving command has been input, the selected icon 532-1 is displayed according to a movement of the mouse pointer 10 or a movement of a touch location of the user.

If the mouse pointer approaches a region on which the icon can be placed while the icon is being moved, light or a flickering effect 550 may be displayed, indicating that the icon can be placed on a corresponding location. If the user places the icon on the corresponding location 550, the icon 532-1 selected by the user is moved to the corresponding location 550.

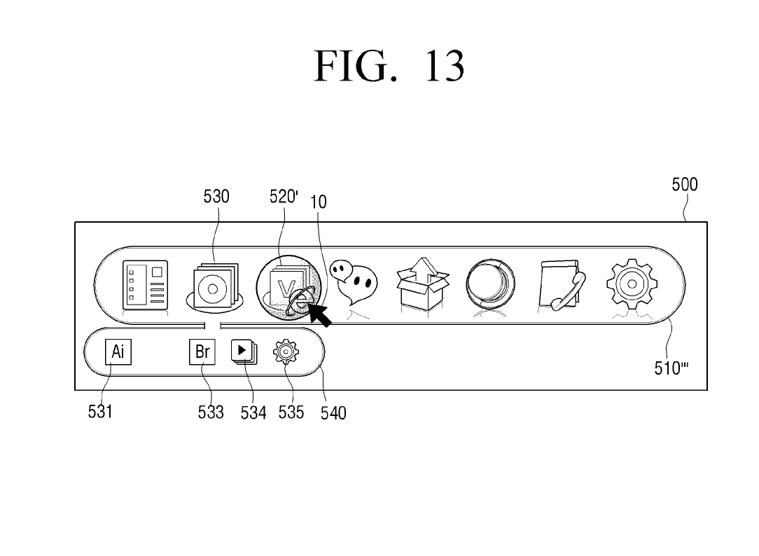

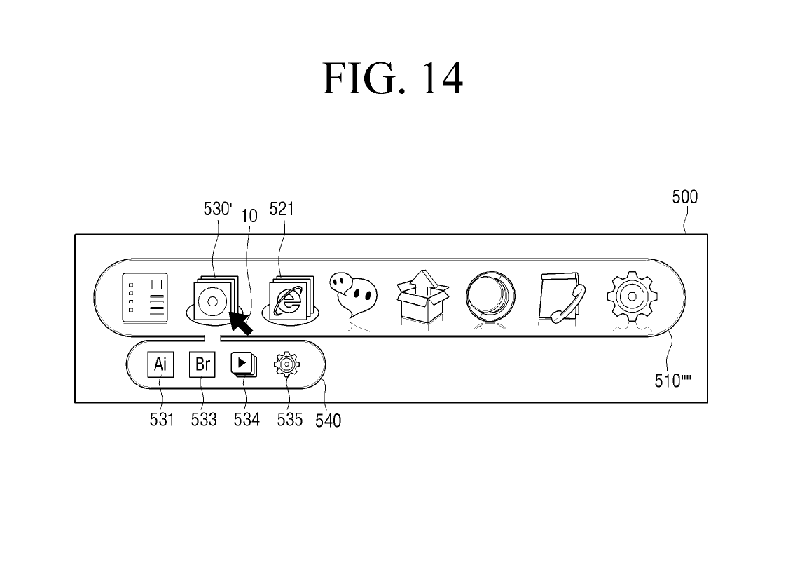

On the other hand, if the icon selected by the user is placed over another icon 520 as illustrated in FIG. 13, the icon 520 on which the mouse pointer is placed is changed to a bubble icon 520′, and, if the selected icon is placed on the corresponding location, the selected icon and the icon 520 over which the selected icon is placed may be grouped to one group as illustrated in FIG. 14.

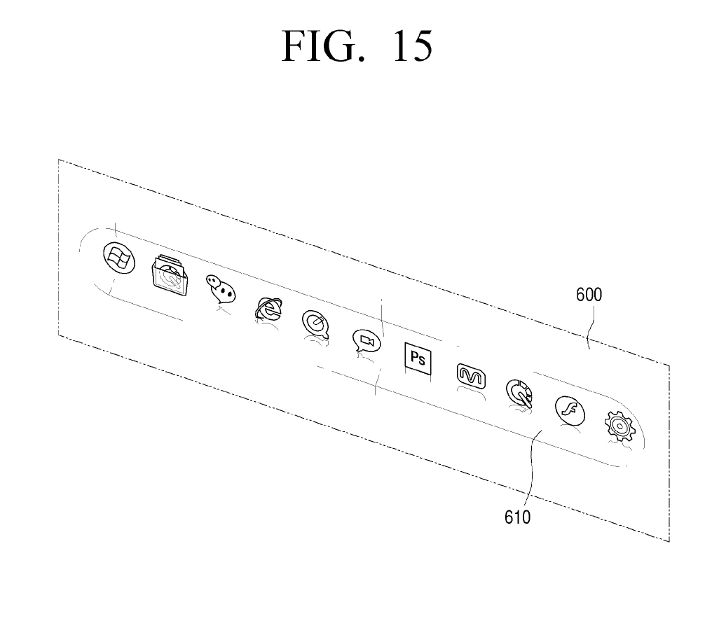

Although the transparent shortcut region is displayed in the above exemplary embodiment, the shortcut region 610 may look like it recedes and is separated from the background by visual illusion as illustrated in FIG. 15.

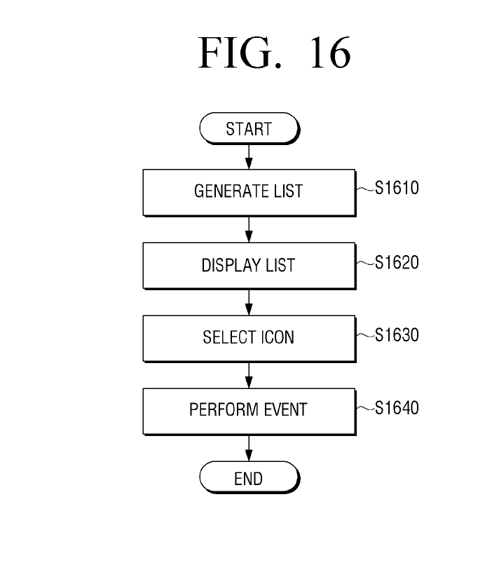

FIG. 16 is a flowchart illustrating a method of executing an application according to an exemplary embodiment of the present general inventive concept.

Referring to FIG. 16, a list is managed at operation S1610. Specifically, a list regarding applications which have been already selected from among a plurality of applications pre-stored in the electronic apparatus may be managed. Managing includes generating a first list and modifying the list by adding or deleting an application after the list has been generated. Therefore, such a managing operation may be performed according to an event such as icon movement or icon deletion on a shortcut region.

Transparency is applied to a shortcut region which includes icons corresponding to the applications included in the list, and the transparent shortcut region is displayed at operation S1620. At this time, the icons may be arranged and displayed based on at least one of installing time of the applications included in the list, frequency of execution, and location selected by the user. If first icons are grouped according to a category, a second icon indicating the grouped icons may be displayed along with the first icons. Also, a third icon and a fourth icon may be displayed along with the first icon.

If one of the displayed icons is selected at operation S1630, an application corresponding to the selected icon is driven at operation S1640. If the selected icon is the second icon, first icons of the applications corresponding to the second icon may be displayed or an extended shortcut region may be displayed. If the selected icon is the third icon, the list of the applications installed in the electronic apparatus may be displayed.

In the method of executing the application described above, the shortcut region having the icon of the application that the user has frequently used is provided to the user, so that the user can easily execute the application. Also, since the method for executing the application according to an exemplary embodiment applies transparency to the shortcut region, the shortcut region is distinguished from the background and also the sense of difference between the shortcut region and the wallpaper, in which a customized user interface is actively performed, can be minimized using visual illusion. The method of executing the application of FIG. 16 may be executed on the electronic apparatus 100 illustrated in FIG. 1, and may be executed on an electronic apparatus having other configurations.

Also, the method of executing the application described above may be realized by a program (or an application) including an algorithm executable in a computer, and the program may be stored in a non-transitory computer readable medium and may be provided.

The non-transitory computer readable medium refers to a medium that stores data semi-permanently rather than storing data for a very short time, such as a register, a cache, and a memory, and is readable by an apparatus. Specifically, the above-described various applications or programs may be stored in a non-transitory computer readable medium such as a CD, a DVD, a hard disk, a Blueray disk, a USB, a memory card, and a ROM, and may be provided.

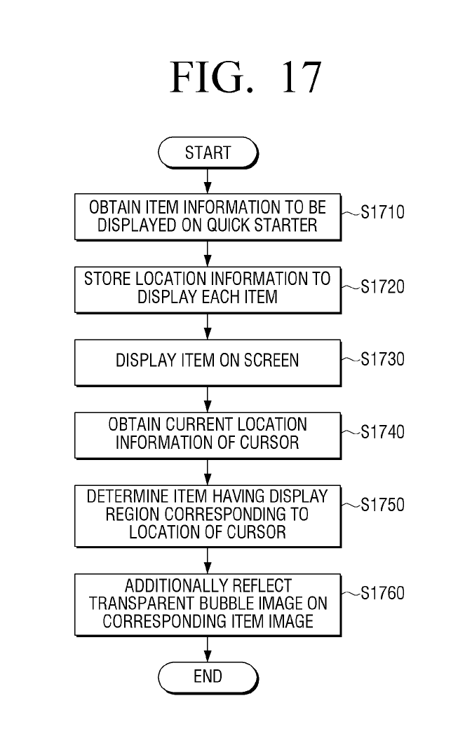

FIG. 17 is a flowchart illustrating a method of executing an application according to an exemplary embodiment of the present general inventive concept.

Referring to FIGS. 1, 2, and 17, icon information (item information) to be displayed on a quick starter is obtained at operation S1710. Specifically, icon information to be displayed on a quick starter may be obtained using an already generated list.

Location information of each icon (item) is stored at operation S1720. Specifically, a location of each icon in the quick starter may be stored as location information.

An icon is displayed on a screen at operation S1730. If it is necessary to display the quick starter, the icon may be displayed using the location information of each icon.

Current location information of a cursor is obtained at operation S1740. Specifically, information on where the cursor in the quick starter is currently located may be obtained.

An icon having a display region corresponding to the location of the cursor is determined at operation S1750. Specifically, information of the corresponding icon may be obtained by comparing item location information which is stored in the item location storage unit 154-1 of the item management unit 154 of the quick starter application 159 and cursor location information provided by the cursor location analysis unit 153.

A transparent bubble image is additionally reflected on the corresponding icon image at operation S1760. Specifically, the effect display unit 154-3 of the item management unit 154 of the quick starter application 159 may additionally display the bubble image on the location of the corresponding icon.

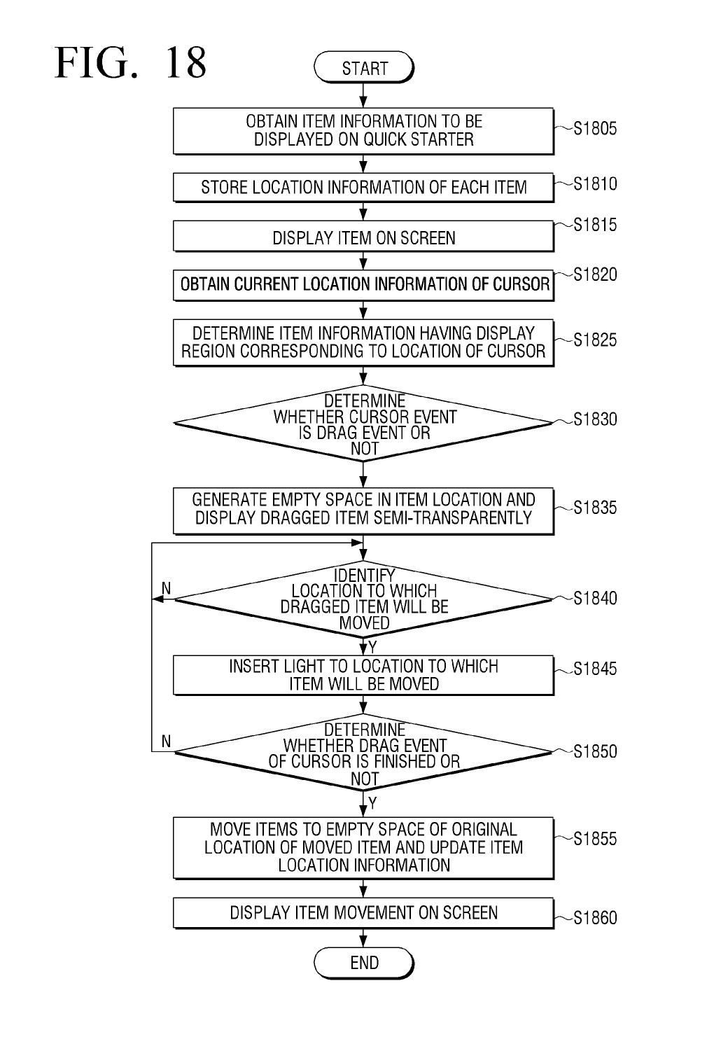

FIG. 18 is a flowchart illustrating a movement of an icon in a shortcut region.

Referring to FIGS. 1, 2, and 18, icon information (item information) to be displayed on a shortcut region is obtained at operation S1805. Specifically, icon information to be displayed on the shortcut region may be read out.

Location information indicating where each icon (item) is displayed is stored at operation S1810. Specifically, the item location storage unit 154-1 of the item management unit 154 of the quick starter application 159 may store location information of each icon.

An icon is displayed on a screen at operation S1815. Specifically, the item display unit 154-2 of the item management unit 154 of the quick starter application 159 may display an icon on a corresponding location using the location information of each icon.

Current location information of a cursor is obtained at operation S1820. Specifically, the cursor location analysis unit 153 obtains location information indicating where the cursor in the shortcut region is currently located.

An icon having a display region corresponding to the location of the cursor is determined at operation S1825. Specifically, information of the corresponding icon may be obtained by comparing icon location information stored in the item location storage unit 154-1 of the item management unit 154 of the quick starter application 159 and cursor location information provided by the cursor location analysis unit.

It is determined whether a cursor event is a drag event at operation S1830. Specifically, the cursor location analysis unit 153 may determine whether the cursor in the shortcut region is dragged to move an icon.

Also, an empty space is generated in the icon location and the icon being dragged is semi-transparently displayed at operation S1835. Specifically, if the cursor in the shortcut region is being dragged, the item display unit 154-2 of the item management unit 154 displays an image of the icon semi-transparently and displays an empty space on an existing location.

A location to which the icon being dragged will be moved is identified at operation S1840. Specifically, the cursor location analysis unit 153 identifies a location of the cursor which is being dragged and determines icon information corresponding to the cursor location. It is determined whether the cursor is located on a left or a right of the image of the current icon with reference to the center.

Light is inserted into the location to which the icon will be moved at operation S1845. Specifically, the location to which the icon being dragged will be moved is received, and, if the location is the left, the effect display unit 154-3 displays a light image on the left, and, if the location is the right, the effect display unit 154-3 displays the light image on the right.

It is determined whether the drag event of the cursor is finished or not at operation S1850. Specifically, the cursor location analysis unit 153 of the quick starter application 159 may determine whether the drag event of the cursor is finished or not.

The icons are moved to the empty space of the original location of the icon which is being moved in sequence, and the icon location information is updated at operation S1855. Specifically, the item location storage unit 154-1 of the quick starter application 159 may move the icons to the empty space of the original location of the icon which is being moved in sequence, and may adjust and update the icon location information.

Icon movement is displayed on the screen at operation S1860. Specifically, the item display unit 154-2 of the quick starter application 159 updates the location information which is changed by the icon movement, and displays the information.

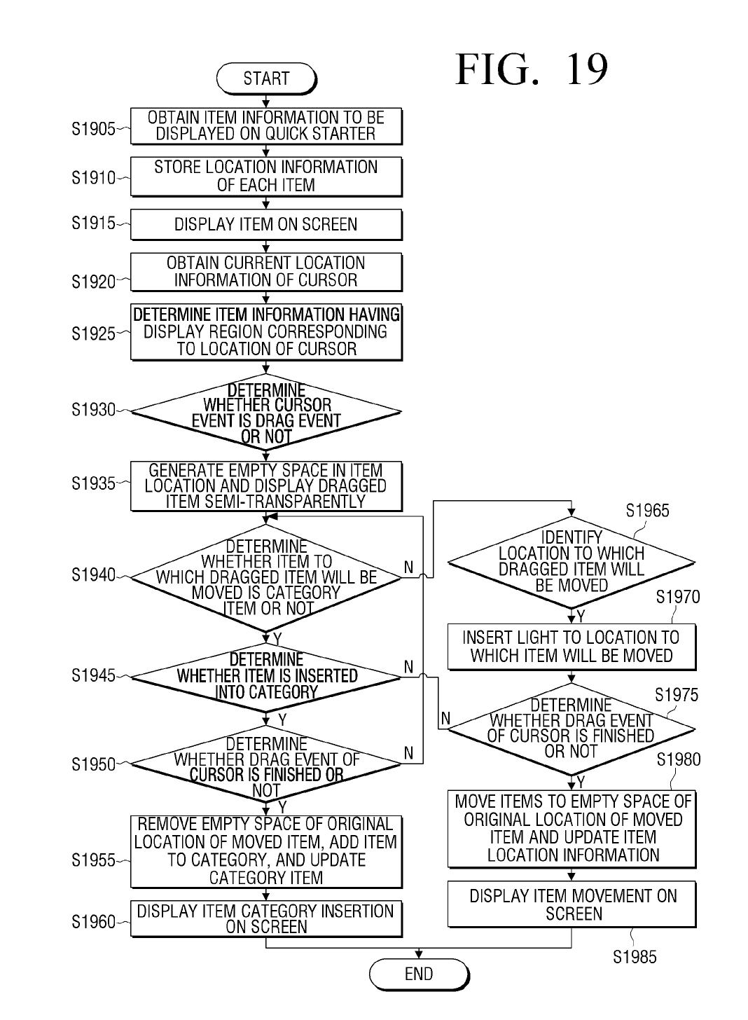

FIG. 19 is a flowchart illustrating a process of managing a plurality of icons as one icon.

Referring to FIGS. 1, 2, and 19, icon information (item information) to be displayed on a shortcut region is obtained at operation S1905. Specifically, icon information to be displayed on the shortcut region may be read out.

Location information indicating where each icon (item) is displayed is stored at operation S1910. Specifically, the item location storage unit 154-1 of the item management unit 154 of the quick starter application 159 may store location information of each item.

An icon is displayed on a screen at operation S1915. Specifically, the item display unit 154-2 of the item management unit 154 of the quick starter application 159 may display the icon on a corresponding location using the location information of each icon.

Current location information of a cursor is obtained at operation S1920. Specifically, the cursor location analysis unit may obtain location information indicating where a cursor in the Q shortcut region is currently located.

An icon having a display region corresponding to the location of the cursor is determined at operation S1925. Specifically, information of the corresponding icon may be obtained by comparing item location information stored in the item location storage unit 154-1 of the item management unit 154 of the quick starter application 159 and the cursor location information provided by the cursor location analysis unit.

It is determined whether a cursor event is a drag event or not at operation S1930. Specifically, the cursor location analysis unit 153 may determine whether the cursor in the shortcut region is dragged to move an icon or not.

An empty space is generated in the icon location and the icon being dragged is transparently displayed at operation S1935. Specifically, if the cursor in the shortcut region is being dragged, the item display unit 154-2 of the item management unit 154 displays an image of the corresponding icon semi-transparently and displays an empty space on the original location.

It is determined whether an icon to which the icon being dragged will be moved is a category icon or not at operation S1940. Specifically, the item location storage unit 154-1 of the item management unit 154 of the quick starter application 159 may determine whether an icon on which the cursor is placed is a category icon or not.

It is determined whether the icon is inserted into the category or not at operation S1945. Specifically, the cursor location analysis unit of the quick starter application 159 analyzes whether the cursor is dragged to insert the icon into the category icon or change the location of the icon.

It is determined whether the drag event of the cursor is finished or not at operation S1950. Specifically, the cursor location analysis unit of the quick starter application 159 may determine whether the drag event of the cursor is finished or not.

The empty space of the original location of the icon which is being moved is removed, the icon is added to the category, and then, updating is performed at operation S1955. Specifically, the item display unit 154-2 removes the empty space corresponding to the original location which is provided by the item location storage unit 154-1 of the item management unit 154 of the quick starter application 159, and updates the category icon image. The item location storage unit 155-1 of the category management unit 155 may store location information of the inserted icon.

The insertion of the icon category is displayed at operation S1960. Specifically, the item display unit 154-2 of the item management unit 154 of the quick starter application 159 may display the icon which is inserted into the category.

Since the operations performed if the location to which the icon being dragged is moved is not a category icon are the same as operations S1840 to 1860 of FIG. 18, operations S1965 to S1985 of FIG. 19 are omitted.

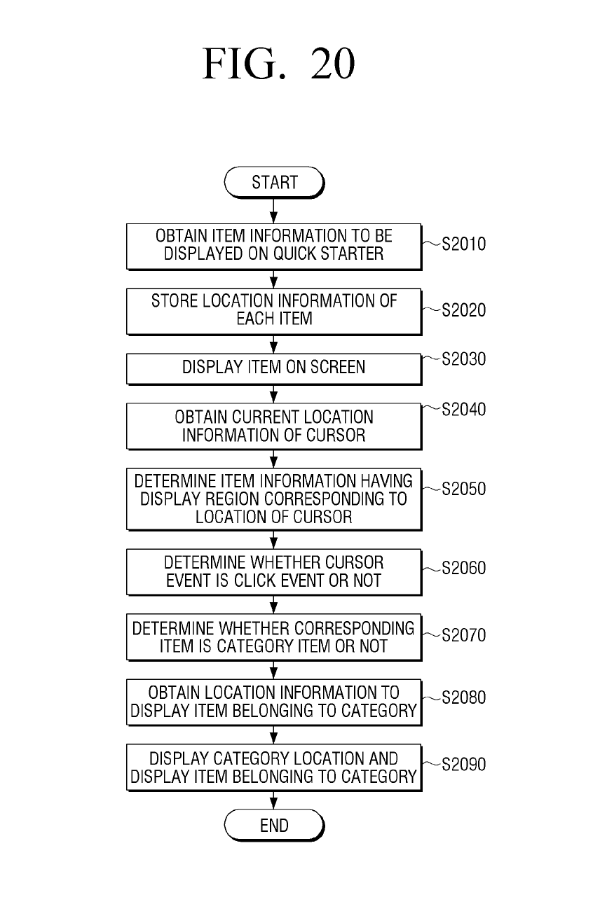

FIG. 20 is a flowchart illustrating an operation of displaying if a second icon is selected.

Referring to FIGS. 2 and 20, icon information (item information) to be displayed on a shortcut region is obtained at operation S2010. Specifically, icon information to be displayed on the shortcut region may be read out.

Location information indicating where each icon (item) is displayed is stored at operation S2020. Specifically, the item location storage unit 154-1 of the item management unit 154 of the quick starter application 159 may store location information of each icon.

An icon is displayed on a screen at operation S2030. Specifically, the item display unit 154-2 of the item management unit 154 of the quick starter application 159 may display an icon on a corresponding location using the location information of each icon.

Current location information on a cursor is obtained at operation S2040. Specifically, the cursor location analysis unit 153 may obtain location information indicating where the cursor in the shortcut region is currently located.

An icon having a display region corresponding to the location of the cursor is determined at operation S2050. Specifically, information of the corresponding icon may be obtained by comparing icon location information stored in the item location storage unit 154-1 of the item management unit 154 of the quick starter application 159 and the cursor location information provided by the cursor location analysis unit 153.

It is determined whether a cursor event is a click event at operation S2060. Specifically, the cursor location analysis unit of the quick starter application 159 may determine whether a corresponding cursor event is a click event or not.

It is determined whether the corresponding icon is a category icon or not at operation S2070. Specifically, the item location storage unit 154-1 in the quick starter application 159 may determine whether the icon on which the current cursor is placed is a category icon or not.

Location information of icons belonging to the category is obtained at operation S2080. Specifically, the category management unit of the quick starter application 159 obtains information on the icons belonging to the category from the item location storage unit 155-1 and calculates a location to display the category.

The category location is displayed and the icons belonging to the category are displayed at operation S2090. Specifically, the item display unit 155-2 may display the icons of the category obtained from the item location storage unit 155-1 by the category management unit 155 of the quick starter application 159 in the category location.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An electronic apparatus comprising:
a storage unit which stores a plurality of applications;
a management unit which manages a list of applications that have been already selected from among the plurality of applications stored in the storage unit;
a user interface which applies transparency to a shortcut region which comprises an icon corresponding to each application included in the list, and displays the transparent shortcut region; and
a controller which, if one of the displayed icons is selected, drives an application corresponding to the selected icon.

2. The electronic apparatus of claim 1, wherein, if a mouse pointer is placed on the icon, the user interface changes the icon on which the mouse pointer is placed to a bubble icon and displays the bubble icon.

3. The electronic apparatus of claim 1, wherein the user interface does not apply transparency to an icon which is displayed on the shortcut region, and applies transparency to a portion of the shortcut region on which an icon is not displayed.

4. The electronic apparatus of claim 1, wherein the user interface further comprises at least one of a third icon which receives a command to display the plurality of applications stored in the storage unit, and a fourth icon which receives a command to change setting of the shortcut region in the shortcut region, and displays the at least one of the third icon and the fourth icon.

5. The electronic apparatus of claim 1, wherein the management unit groups the already selected applications according to a predetermined category,
wherein the user interface displays a second icon which corresponds to the category of the grouped applications along with the icon.

6. The electronic apparatus of claim 5, wherein, if a mouse pointer is placed on the second icon or if the second icon is selected, the user interface displays an extended shortcut region which comprises an icon corresponding to each of the applications grouped according to the category on a lower portion or an upper portion of the second icon.

7. The electronic apparatus of claim 6, wherein the user interface displays the icon in the extended shortcut region in a different size from that of the icon in the shortcut region.

8. The electronic apparatus of claim 6, wherein, if an icon in the extended shortcut region is moved to the shortcut region, the management unit excludes an application corresponding to the moved icon from the group corresponding to the second icon.

9. The electronic apparatus of claim 1, wherein, if a command to move one of the icons is input, the user interface displays the icon which is instructed to be moved on a mouse pointer or a touch location of a user.

10. The electronic apparatus of claim 1, wherein the management unit updates the list based on a location on which the icon which is instructed to be moved is placed.

11. The electronic apparatus of claim 1, wherein, if the icon which is instructed to be moved is placed over another icon, the management unit groups the icon which is instructed to be moved and another icon into one category.

12. The electronic apparatus of claim 1, wherein, if the icon which is instructed to be moved is placed over a second icon corresponding to one or more applications grouped according to a category, the management unit adds an application corresponding to the icon which is instructed to be moved to the category.

13. A method of executing an application of an electronic apparatus, the method comprising:
managing a list of applications that have been already selected from among a plurality of application pre-stored in the electronic apparatus;
applying transparency to a shortcut region which comprises an icon corresponding to each application included in the list, and displaying the transparent shortcut region;
selecting one of the displayed icons; and
driving an application corresponding to the selected icon.

14. The method of claim 13, wherein the displaying comprises, if a mouse pointer is placed on the icon, changing the icon on which the mouse pointer is placed to a bubble icon, and displaying the bubble icon.

15. The method of claim 13, wherein the displaying does not apply transparency to an icon which is displayed on the shortcut region, and applies transparency to a part of the shortcut region on which an icon is not displayed.

16. The method of claim 13, wherein the displaying comprises providing at least one of a third icon which receives a command to display the plurality of applications stored in the storage unit, and a fourth icon which receives a command to change setting of the shortcut region in the shortcut region, and displaying the at least one of the third icon and the fourth icon.

17. The method of claim 13, wherein:
the managing comprises grouping the already selected applications according to a predetermined category; and
wherein the displaying comprises displaying a second icon which corresponds to the category of the grouped applications along with the icon.

18. The method of claim 17, wherein the displaying comprises, if a mouse pointer is placed on the second icon or if the second icon is selected, displaying an extended shortcut region which comprises an icon corresponding to each of the applications grouped according to the category on a lower portion or an upper portion of the second icon.

19. The method of claim 18, wherein the displaying comprises displaying the icon in the extended shortcut region in a different size from that of the icon in the shortcut region.

20. The method of claim 18, wherein the managing comprises, if an icon in the extended shortcut region is moved to the shortcut region, excluding an application corresponding to the moved icon from the group corresponding to the second icon.

21. The method of claim 13, wherein the displaying comprises, if a command to move one of the icons is input, displaying the icon which is instructed to be moved on a mouse pointer or a touch location of a user.

22. The method of claim 13, wherein the managing comprises updating the list based on a location on which the icon which is instructed to be moved is placed.

23. The method of claim 13, wherein the managing comprises, if the icon which is instructed to be moved is placed over another icon, grouping the icon which is instructed to be moved and another icon into one category.

24. The method of claim 13, wherein the managing comprises, if the icon which is instructed to be moved is placed over a second icon corresponding to applications grouped according to a category, adding an application corresponding to the icon which is instructed to be moved to the category.

25. A non-transitory computer readable recording medium which comprises computer-readable codes as a program to execute the method of claim 13.
